(19) United States
(12) Patent Application Publication
(10) Pub. No.: US 2019/0329328 A1
(43) Pub. Date: Oct. 31, 2019

(54) POWER TOOL WITH WORKING IMPLEMENT ATTACHMENT

(71) Applicant: ATLAS COPCO INDUSTRIAL TECHNIQUE AB, Stockholm (SE)

(72) Inventor: Jens-Eric VESTURLID, Norrtälje (SE)

(73) Assignee: ATLAS COPCO INDUSTRIAL TECHNIQUE AB, Stockholm (SE)

(21) Appl. No.: 16/474,593

(22) PCT Filed: Dec. 20, 2017
(86) PCT No.: PCT/EP2017/083796

§ 371 Date: Jun. 28, 2019

(30) Foreign Application Priority Data
Jan. 2, 2017 (SE) 1730001-3

(51) Int. Cl. B23B 31/20; B23B 45/04

(52) U.S. Cl. CPC B23B 31/201; B23B 45/04

(57) ABSTRACT

A portable power tool includes a housing, a rotation motor supported in the housing and drivingly connected to an output shaft, and a connection device for attachment of a working implement to the output shaft. The connection device includes a conical coaxial socket portion formed integral with the output shaft and the working implement carrying collet to be received in the socket portion. The collet is radially elastic and intended to exert a radial clamping force on the working implement. A retaining sleeve partly surrounds the output shaft and is coupled to the output shaft via a thread connection. The retaining sleeve is provided with a radial inner flange for engaging and transferring an axial thrust force onto the collet to obtain a radial clamping force on the working implement introduced in the collet as the thread connection is tightened.

The invention relates to a portable power tool comprising a housing with a handle for manual support of the tool, and a rotation motor drivingly connected to an output shaft which is adapted to carry a working implement.

In particular, the invention concerns a portable power tool wherein the output shaft is provided with a connection device for the attachment of a working implement, wherein this connection device comprises a collet for retaining the working implement relative to the output shaft.

The main problem at prior art power tools of the above mentioned type and which is intended to be solved by the invention is that an accurate concentricity of a working implement in relation to the output shaft could not be guaranteed, and that the working result performed by the working implement would be less accurate.

In particular, the problem to be solved by the invention is related to the above mentioned prior art type of power tools wherein a working implement is attached to the output shaft via a separate collet which is supported relative to the output shaft via a thread connection. This thread connection is a weak link as to obtain an acceptable rotation accuracy of the working implement, i.e. to obtain an accurate concentricity of the collet and hence the working implement relative to the output shaft.

It is an object of the invention to provide a portable power tool of the above mentioned type by which an accurate concentricity of an attached working implement in relation to the output shaft is guaranteed.

It is a further object of the invention to provide a portable power tool of the above mentioned type wherein the collet for retaining a working implement is supported directly and solely by the surface of a coaxial socket portion formed integral with the output shaft, whereby is guaranteed an accurate concentricity of the working implement in relation to the output shaft.

Still further objects and advantages of the invention will appear from the following specification and claims.

A preferred embodiment of the invention will be described in detail with reference to the accompanying drawings.

In the drawings

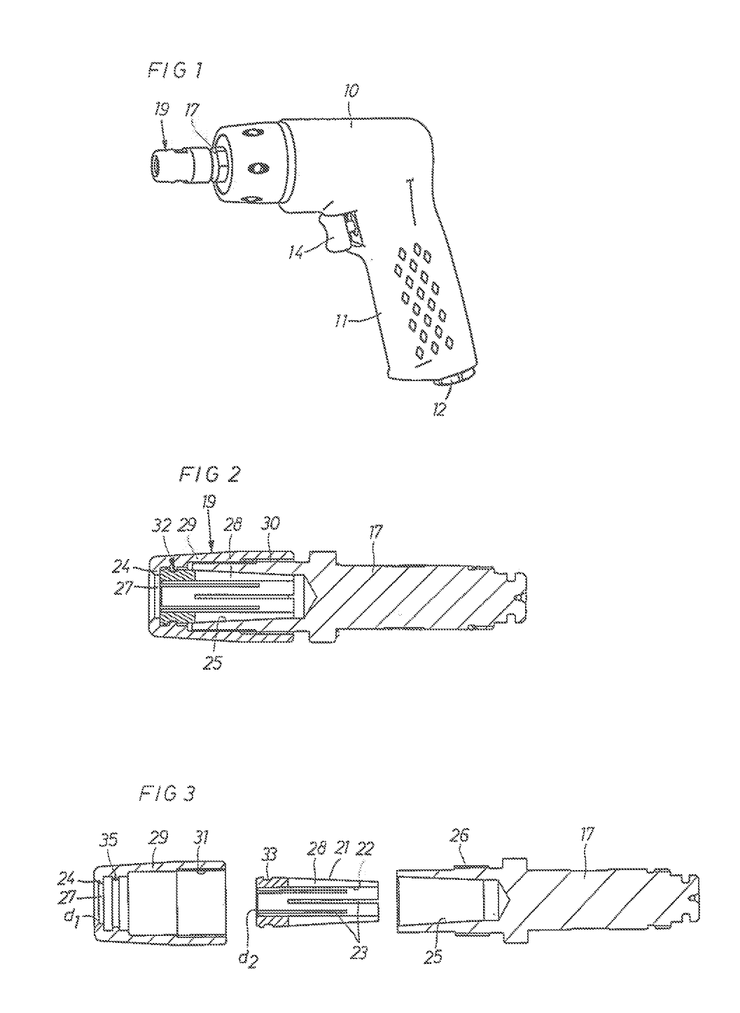

FIG. 1 shows a perspective view of a power tool according to the invention.

FIG. 2 shows a longitudinal section through the output shaft with a connection device for a working implement.

FIG. 3 shows an exploded view of the device in FIG. 2.

The power tool illustrated in the drawing figures is a portable pneumatic power tool intended for operations like drilling, milling or reaming. The working implements to be used in these operations should have a cylindrical stem to be received in a collet type connection device attached to the output shaft of the tool.

The illustrated power tool comprises a housing 10 formed with a pistol type handle 11 for manual support of the tool, and a pneumatic rotation motor. The handle 11 is provided with a coupling 12 for a pressure air line and a throttle valve operated by a trigger 14 for controlling the pressure air supply to the motor. The latter is drivingly connected to an output shaft 17 via a power transmission in the form of a reduction gearing.

Since the motor and the power transmission as well as the power supply means are of a well-known type and do not form any part of the invention those parts are not described in further detail.

The output shaft 17 extends out through a front opening of the housing 10 and is provided at its forward end with a connection device 19 for attachment a working implement. The connection device 19 comprises a conical socket portion 25 formed integrally and coaxially with the output shaft 17 and a collet 28 to be received in the socket portion 25 and intended to retain the working implement.

The collet 28 is of a conventional design having a conical outer surface 21 adapted to fit the conical the socket portion 25 in the output shaft 17 and a cylindrical inner surface 22 for engaging a stem portion of a working implement attached to the tool. The collet 28 is also provided with a number of overlapping longitudinal slots 23 by which is provided a radial elasticity of collet.

The connection device 19 further comprises a retaining sleeve 29 which is movably supported on the outside of the socket portion 25 of the output shaft 17. The retaining sleeve 29 is connected and axially adjustable relative to the output shaft 17 via a thread connection 30 which comprises an inner thread 31 on the retaining sleeve 29 and a threaded portion 26 on the output shaft 17. This thread connection 30 enables an axial thrust force to be exerted on the collet 28 by tightening the retaining sleeve 29 thereby locking the working implement to the output shaft 17 via the collet 28. For that purpose the retaining sleeve 29 is provided with an inner radial flange 24 which defines a central opening 27 for introduction of a working implement. The flange 24 is also intended to engage axially the outer end of the collet 28 to thereby transfer the axial thrust force on the latter as the sleeve 29 is threaded onto the output shaft 17. This axial thrust force urges the collet 28 further into the conical socket portion 25 resulting in a radial compression of the collet 28 and a locking of an attached working implement. The diameter d₁ of the opening 27 is bigger than inner diameter d₂ of the collet 28 to ensure that the flange 24 and, hence, the retaining sleeve 29, will be kept out of contact with the working implement introduced in the collet 28.

It is essential that the diameter d₁ of the central opening 27 defined by the flange 24 is bigger than the inner diameter d₂ the collet 28 so as to ensure that a fitted working implement does not have any radial contact with retaining sleeve 29, because the thread connection 30 between the retaining sleeve 29 and the out shaft 17 would not offer an accurate enough centricity of the retaining sleeve 29 to form an accurate enough radial support for the working implement. In other words, the thread connection would not guarantee an accurate enough centricity of the working implement to make the latter produce an acceptable high standard of the working result at use of the tool. That was the problem of the working implement connection devices at prior art power tool as mentioned above. Instead, the radial support of the working implement according to the invention is formed solely by the collet 28 in its cooperation with the conical socket portion 25 integral with the output shaft 17.

At its forward end the collet 28 is provided with an annular groove 33 which is intended to receive an inner annular rib 35 on the retaining sleeve 29. This rib and groove arrangement form a non-rigid snap coupling 32 between the retaining sleeve 20 and the collet 28 which means that the collet 28 due to its radial elasticity will be slightly compressed and make the rib 35 snap into a locking position with the groove 33 as the two parts are pressed together axially. The collet 28 and the retaining sleeve 29 thereby form an assembly to be fitted to the output shaft 17 as a unit which, accordingly, will facilitate mounting of a selected collet to the output shaft 17. The snap coupling 32, however, offers a loose connection only between the two elements and does not have any influence on the radial support of the collet 28 relative to the output shaft 17.

In preparing the power tool for operation the retaining sleeve 29 is removed from the output shaft 17 and a selected collet 28 suitable for the working implement to be used is fitted. The retaining sleeve 29 and the collet 28 are locked together via the snap coupling 32, whereafter this collet/retaining sleeve-assembly is mounted on the output shaft 17 with the thread 31 of the retaining sleeve 29 engaging the threaded portion 26 on the output shaft 17. After the intended working implement has been introduced into the collet 28 the retaining sleeve 29 is further tightened relative to the output shaft 17 by a suitable spanner. By engagement of the flange 24 and the end surface of the collet 28 the latter is now forced further into the conical socket portion 25, thereby being radially compressed and producing a clamp force on the working implement to lock the latter relative to the output shaft 17.

Since the collet 28 is supported and guided directly and solely by the surface of the conical socket portion 25 of the output shaft 17 an accurate centricity of the working implement stem is guaranteed, which means that the work being performed by the working implement would be guaranteed a high quality.

It is to be understood though that the invention is not limited to the illustrated and described example but may be freely varied within the scope of the claims. For instance, the pneumatic motor may be replaced by an electric motor with a corresponding power supply means fitted to the housing, for instance a battery attachment.

1-4. (canceled)

5. A portable power tool comprising a housing, a rotation motor supported in the housing and drivingly connected to an output shaft, and a connection device for attachment of a working implement to the output shaft, wherein:
the connection device comprises a conical coaxial socket portion formed integral with the output shaft and the working implement carrying collet to be received in the socket portion,
the collet is radially elastic and intended to exert a radial clamping force on the working implement,
a retaining sleeve partly surrounding the output shaft and coupled to the output shaft via a thread connection, and
the retaining sleeve is provided with a radial inner flange for engaging and transferring an axial thrust force onto the collet to obtain a radial clamping force on the working implement introduced in the collet as the thread connection is tightened.

6. The portable power tool according to claim 5, wherein the flange defines a central opening for introduction of the working implement, the opening having a bigger diameter (d₁) than an inner diameter (d₂) of the collet.

7. The portable power tool according to claim 5, wherein a coupling is provided to form a non-rigid connection between the collet and the retaining sleeve.

8. The portable power tool according to claim 6, wherein a coupling is provided to form a non-rigid connection between the collet and the retaining sleeve.

9. The portable power tool according to claim 6, wherein the coupling comprises an inner annular rib on the retaining sleeve and a matching annular groove on the collet.

10. The portable power tool according to claim 7, wherein the coupling comprises an inner annular rib on the retaining sleeve and a matching annular groove on the collet.

11. The portable power tool according to claim 8, wherein the coupling comprises an inner annular rib on the retaining sleeve and a matching annular groove on the collet.
